(19) United States
(12) Patent Application Publication
(10) Pub. No.: US 2026/0017662 A1
(43) Pub. Date: Jan. 15, 2026

(54) CONTEXTUAL PAYMENT AUGMENTATION

(71) Applicant: Wells Fargo Bank, N.A., San Francisco, CA (US)

(72) Inventors: Kasiperumal Achappan, Bengaluru (IN); Ramya Balasubramanian, Hyderabad (IN)

(21) Appl. No.: 18/771,152

(22) Filed: Jul. 12, 2024

(51) Int. Cl. G06Q 20/42

(52) U.S. Cl. CPC G06Q 20/42

(57) ABSTRACT

Augmenting an electronic payment by generating and interposing into the payment workflow a text string that includes a number corresponding to the payment amount. The text string can be an educational text string that is interposed before, or in conjunction with, a portion of the payment workflow that includes a request to confirm the payment. The interposed educational text string can be generated by a generative artificial intelligence model (GAIM). The GAIM can generate the interposed educational information based on the payment amount and one or more contextual factors about the payment.

### BACKGROUND

Customers of financial institutions can initiate electronic payments from financial accounts managed by the financial institutions. To initiate such an electronic payment, an interface is provided on an electronic device. Input is provided to the interface that identifies the payee, the payor financial account, and an amount of the payment. Once this information is entered, another interface is generated prompting the payor to confirm the payment. Upon confirmation of the payment, the payment is initiated.

### SUMMARY

In general terms, the present disclosure relates to augmentation of an electronic payment workflow. The augmentation includes an interposition, during the electronic payment workflow, of a text string that includes a number corresponding to an amount of the requested payment.

In one aspect, the present disclosure relates to a computer-implemented payment method, including: receiving, by a server, a payment request from a client electronic computing device, the payment request including an amount of a payment; generating, by the server, a prompt based on the amount; feeding, by the server, the prompt to a generative artificial intelligence model (GAIM); generating, by the GAIM and in response to the prompt, a text string that includes a number corresponding to the amount; generating, by the server, first signals that cause the client electronic computing device to display the educational text string, and receiving, by the server, second signals from the client electronic computing device in response to a request to confirm the payment, the second signals indicating whether the payment has been confirmed.

In another aspect, the present disclosure relates to a computer-implemented payment method, including: receiving, by a client electronic computing device, input corresponding to a payment request, the payment request including an amount of a payment; transmitting the payment request from the client electronic computing device, including forking the payment request from the client electronic computing device to each of a server and an electronic payment service device, the server being associated with a trained generative artificial intelligence model (GAIM); receiving, by the client electronic computing device and from the server, an educational text string generated by the trained GAIM that includes a number corresponding to the amount; receiving, by the client electronic computing device and from the electronic payment service device, a confirmation request to confirm the payment; and receiving, by the client electronic computing device, another input responding to the confirmation request, the another input causing the payment request to be initiated or causing the client electronic computing device to request at least one revision to the payment request.

In another aspect, the present disclosure relates to a system for managing payments, including: a server; an electronic payment service device; processors included in the server and the electronic payment service device; and non-transitory computer readable storage storing instructions which, when executed by the processors, cause the processors to: process in parallel by the server and the electronic payment service device a payment request received from a client electronic computing device, causing: the server to generate a prompt; the server to feed the prompt to a trained generative artificial intelligence model (GAIM); the trained GAIM to generate an educational text string including a number corresponding to an amount of a payment included in the payment request; the server to transmit the educational text string to the client electronic computing device; the electronic payment service device to generate a confirmation request to confirm the payment; and the electronic payment service device to transmit the confirmation request to the client electronic computing device.

Each of these aspects, and other aspects, of the present disclosure, can be implemented in a variety of ways including, for example, in the form of one or more of a computing system, a computing device, a method (e.g., a computer-implemented method), non-transitory computer-readable storage, a plurality of computing devices, and the like.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example contextual payment augmentation system.

FIG. 2 shows an example generative artificial intelligence model (GAIM) prompt template that can be used by the system of FIG. 1.

FIG. 3 shows an example user interface that can be generated by the system of FIG. 1.

FIG. 4 shows an example method that can be performed by the system of FIG. 1.

FIG. 5 shows another example method that can be performed by the system of FIG. 1.

FIG. 6 shows example physical components of portions of the system of FIG. 1.

### DETAILED DESCRIPTION

Financial institutions provide platforms, e.g., via web applications, software applications installed on client electronic computing devices, and dedicated payment terminals at point-of-sale locations, that allow their customers to make electronic payments from transaction accounts managed by the financial institution to payee accounts. The platform is configured to allow a customer to log into or otherwise access a financial account using credentials.

Once logged in or otherwise accessing the account, the customer can request, via the platform, to make a payment from the financial account, by identifying the financial account, a payee or payee account, and an amount of the payment and submitting these payment details. The submitted details of the payment request are then presented in a formalized format on the client device together with a prompt to the customer to confirm the requested payment.

If the payment request is confirmed, the payment is initiated, e.g., using a clearinghouse. Assuming there is sufficient balance in the customer's financial account to make the payment, the funds corresponding to the payment amount are then transferred from the customer's account to the payee account.

As the term is used herein, “payment” refers to any transferring of money, such as a transfer of money from a transaction account to another account owned by the same user, or from a transaction account of a user to an account of a third party to, e.g., pay for a good or a service provided by the third party.

As the term is used herein, “user” is a customer of a financial institution that holds a transaction account managed by the financial institution.

As the term is used herein, “transaction account” refers to any account from which a payment can be made, such as a checking account, a savings account, an investment account, a line of credit, a credit card account, and the like.

Though convenient, electronic payments present opportunities for errors. For example, a customer requesting payment may enter and confirm payment in the incorrect amount, or payment to an incorrect payee. This can occur, for example, because the customer is distracted, or simply inadvertently taps the wrong digits when entering the payment amount. The errors can be significant. For instance, a customer can request and confirm payment in the amount of 1,000 dollars, when 100 dollars or 10,000 dollars was actually intended. Such errors can be costly and time consuming for the customers and financial institutions to rectify. In some cases, unintended payment sums are absconded and the customer and/or financial institution must incur the financial loss due to the errant payment.

The present disclosure alleviates one or more of the foregoing drawbacks of electronic payment systems and methods.

According to the present disclosure, a checkpoint is introduced into electronic payment workflow. The checkpoint is generated by an augmentation workflow that is parallel to the payment workflow. The augmentation workflow is managed by at least one computing device that is discrete from the computing device(s) used in the payment workflow.

The checkpoint includes a presentation to the customer, before the customer confirms submitted payment details, of an auto-generated text string. In some examples, the text string can be an educational text string. The text string includes a number corresponding to the amount of the payment that was entered by the customer. For example, if the payment request is for 1,000 dollars, the text string can include information about an event that occurred 1,000 years ago, or the baseball player who first recorded 1,000 runs batted in.

The text string can enrich the customer's electronic payment experience, e.g., by teaching the customer information they did not already know.

The checkpoint also serves to facilitate the customer's reconsideration of the requested payment to ensure that all of the payment details submitted, such as the payment amount, are correct. For example, the customer may gloss over a request to confirm payment in the amount of 1,000 dollars and confirm the payment without much or any reconsideration, but recognize that something is amiss in the payment amount submitted if a checkpoint appears providing an educational text string that includes the number 1,000, the checkpoint triggering the customer to go back and correct the payment amount before confirming payment.

In some examples, the customer is required to interact with the educational text string (e.g., by liking or disliking it) as part of the augmentation workflow before the customer is permitted to confirm, revise, or cancel the requested payment.

These advantages and solutions are realized by specific technical implementations of computing devices involved in the two parallel workflows—the payment workflow and the augmentation workflow. Aspects of these workflows can be performed in parallel and simultaneously by different computing devices, maximizing efficiency of the overall electronic payment system and/or method while still advantageously providing the advantages of the checkpoint.

Technical implementations of these advantages and solutions also include training a generative artificial intelligence model (GAIM) with curated training data and using the trained GAIM to generate the educational text strings. These technical implementations can include a feedback loop whereby a response or feedback to an educational text string during an augmentation workflow can be fed back to the trained GAIM to train its underlying algorithm(s) further, thereby enabling the trained GAIM to provide improved educational text strings during future augmentation workflows.

Technical implementations of these advantages and solutions also include auto-engineering prompts, e.g., using a prompt template, based on submitted payment details such as the payment amount, and contextual data about the payment and/or the user requesting the payment. The auto-generated prompts are fed to the GAIM during the augmentation workflow. The GAIM generates educational text strings based on the autogenerated prompts. The educational text strings are then provided to the client electronic computing device to augment the electronic payment workflow.

These and other examples herein are technological improvements specifically within the technological field of electronic payments.

### System Overview

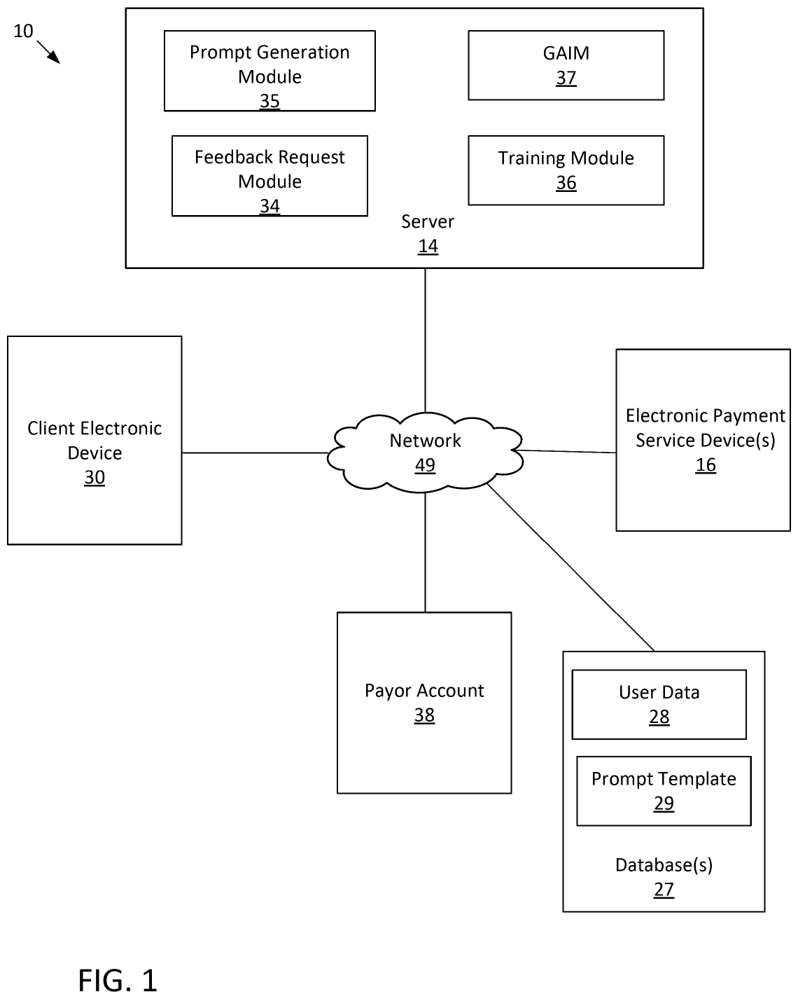

FIG. 1 shows an example payment augmentation system 10.

The system 10 includes a server 14, one or more electronic payment service devices (EPSD) 16, a client electronic device 30, one or more databases 27, and a payor account 38 that are networked together via a network 49. The various devices shown generate, transmit and receive various signals carrying the data and metadata as described herein between different devices within the system 10.

The server 14 can be managed by a financial institution. The server 14 can represent a single server, e.g., that is operated exclusively by a financial institution. Alternatively, the server 14 can include multiple computing devices, with the functionality of the server 14 being distributed across the multiple computing devices using the network 49. For instance, the server 14 can represent a computing cloud that a financial institution accesses to perform functions of the server 14 described herein.

The payor account 38 is supported by one or more computing devices, such as the server 14.

The network 49 can be any suitable network or combination of networks for operably coupling computing devices to one another so that the computing devices can communicate data signals between one another.

The EPSD 16 can be any electronic computing device or combination of electronic computing devices that provide an electronic payment service. For example, the EPSD 16 can represent an automated clearinghouse (ACH) that facilitates an electronic money transfer from the payor account 38 to a payee account.

Upon receipt of payment request details (e.g., identification of payor account, identification of payee account, and payment amount), the EPSD 16 can generate and transmit to the client device 30 a request to confirm or not to confirm the requested payment. For example, the EPSD 16 can generate and transmit to the client device 30 a request to confirm, revise, or cancel the requested payment.

If via the client electronic device 30 the payment request is confirmed, then the EPSD receives a signal from the client device 30 that causes the EPSD 16 to initiate the actual payment. If via the client electronic device 30 the EPSD 16 receives a signal from the client device that the payment request is canceled, then no further action by the EPSD 16 takes place other than to send an acknowledgement to the client electronic device 30 of the canceled payment request.

If via the client electronic device 30 the EPSD 16 receives a signal from the client device that the payment request should be revised, then the payment workflow can revert to the previous point and allow the payment details to be revised via the client device 30 and then resubmitted.

The client electronic device 30 can include, for example, a smartphone, a tablet, a smartwatch or other smart wearable technology, a virtual reality device, an augmented reality device, a desktop computer, a transaction card reader, a point-of-sale terminal, and the like.

The server 14 stores, or has access via the network 49, to one or more databases 27, that store user data 28 for customers of a financial institution. For example, such user data 28 can include account data about the payor account 38. The user data 28 can include data about education of users (e.g., the degrees that different users have achieved and from which institutions), data about employers of the users (e.g., the user's occupations and income), data about family members of the users (e.g., whether users have children and, if so, the stages of life of those children (e.g., babies, grade school students, high school students, college students, and the like), data about hobbies of the users, data about travel histories of the users, including countries and cities where they have traveled, data about geographic areas surrounding homes of the users, data about spending habits of the users (e.g., that users frequently spend money on attending sports games or pay for a sports content streaming service), other personal data about the users (e.g., age) and the like.

The user data 28 can also include data about feedback by the users to previous educational text strings generated in response to previous payment requests, such as likes or dislikes of the users to previously presented educational text strings during previous payment request checkpoints.

The user data 28 can also include information associated with the payor account 38, such as an account number, a type of account (e.g., checking, savings, credit), the name of the account owner, whether the account is a business account or a personal account, user contact information, user login credentials, and the like.

The user data 28 is segregated by user such that when a particular payor account 38 is accessed or logged into from the client device 30, only the user data 28 associated with the owner of that account (and not a different user associated with a different account) is used for the parallel augmentation workflow.

The database(s) 27 also includes a prompt template 29 that is used by the server 14 to generate prompts that are fed to the GAIM 37 to generate educational text strings at checkpoints during payment request workflows.

The server 14 includes a prompt generation module 35. In response to a payment request received by the server 14 from the client device 30, the prompt generation module 35 is configured to generate a prompt using the prompt template 29, and then feed the generated prompt to the GAIM 37. The prompt generation module 35 fills in the template 29 based on the amount of the requested payment, payment contextual data received from the client device 30, and the user data 28 corresponding to the payor account 38 from which the payment has been requested.

The payment contextual data can be provided as metadata packaged and transmitted from the client electronic device 30 together with the actual payment request. Such contextual data can include, for example, the time of day the payment request is made, the date the request is made, the day of the week the request is made, the geolocation of the client device 30, the identification of the merchant hosting the client device 30 (e.g., a particular retail store), the type of good or the type of service being paid for, and the like.

The user data 28 that can be used by the prompt generation module 35 can include any of the types of user data 28 described herein.

Once a prompt has been generated by the prompt generation module 35, the prompt is fed to the GAIM 37. The GAIM is trained to generate educational text strings based on the prompts it is fed. In addition to the prompts themselves, the GAIM can access the same or different user data 28 and payment contextual data that was used by the prompt generation module 35 in order to craft an educational text string. The GAIM 37 may access any corpus of data (e.g., the Internet) from which to identify and construct the educational text string.

In the example depicted, the GAIM 37 is a component of the server 14. In other examples, the GAIM, or components of the GAIM, are hosted remotely from the server (e.g., on a cloud) and the server accesses the GAIM as needed.

During a payment workflow, the server 14 transmits the educational text string generated by the GAIM to the client device 30, which then displays or otherwise outputs (e.g., via a speaker) the educational text string.

The feedback request module 34 generates a request for feedback to the educational text string. The feedback request accompanies the educational text and can be displayed or otherwise output by the client device 30 simultaneously, or after some period of time.

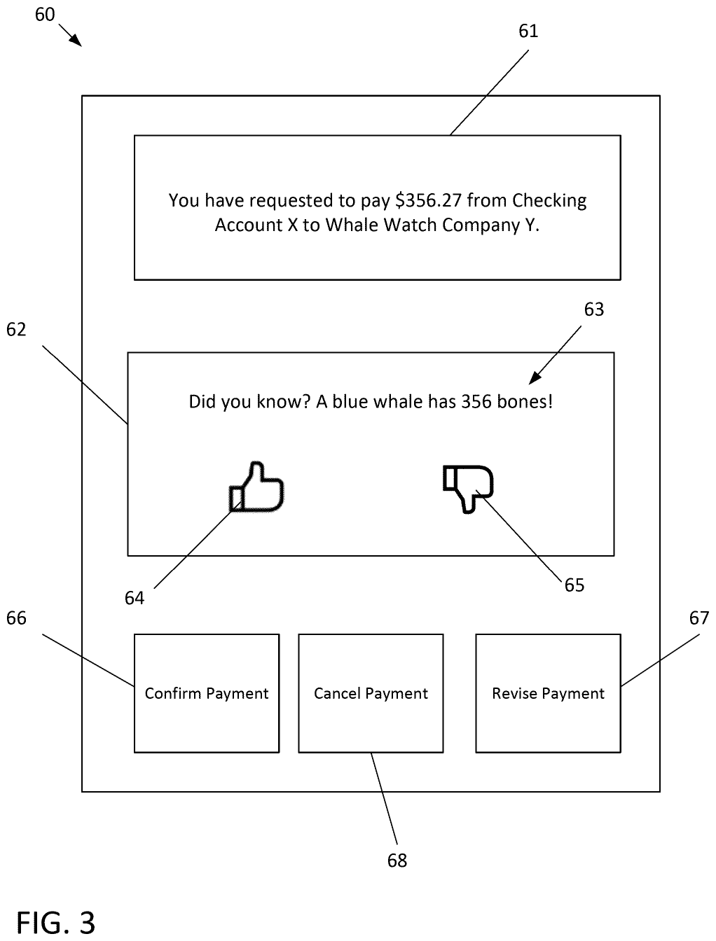

In some examples, the request generated by the EPSD 16 to confirm, cancel, or revise a payment request is provided to the client device 30 simultaneously with the educational text string and the request for feedback, allowing an output, such as the interface 60 shown in FIG. 3, to be generated by the client device 30 and interacted with by a user. In these examples, the EPSD 16 and the server 14 work in parallel to generate payment confirmation requests and educational text strings and, in some examples, also with requests for feedback to the educational text strings.

In some examples, the request generated by the EPSD 16 to confirm, cancel, or revise a payment request is provided to the client device 30 only after the user has reacted (e.g., with approval or disapproval) to the educational text string and the request for feedback.

The feedback request module 34 is also configured to receive the feedback (e.g., approval or disapproval) from the client device 30 relating to the educational text string and provide that feedback to the user data 28 and/or to the training module 36 and/or to the GAIM 37 to further train the GAIM (e.g., to cause the GAIM 37 to provide improved educational text strings).

The training module 36 is configured, via supervised and/or unsupervised deep learning or other machine learning techniques, to train the GAIM 37 to provide suitable, desirable educational text strings during augmentation workflows based on the corresponding user data and payment contextual data. For example, the training module 36 can be configured to train an algorithm of the GAIM 37 to tune parameters, add parameters, or remove parameters based on training data such as the user data 28. For example, the training module 36 can train the GAIM 37 to generate, for a given payor account 38, only educational text strings that relate to one or more of the occupation, school, hobbies, spending habits, and/or geolocation of the user that owns the payor account 38, and only educational text strings that, based on feedback received by the feedback request module 34 to prior educational text strings during prior augmentation workflows, the user is predicted to approve of.

### Example Implementations

Example implementations of the components of the system of FIG. 1 will now be described.

Referring to FIG. 1, a user logs into their financial institution's payment platform via a software application installed on their smartphone 30. The user, and their smartphone 30, are currently located in Paris, France. The user enters a payment request via the payment platform. The payment request identifies the payor account 38, a payee account of a refrigerator maintenance company, and a payment amount of 1,889.22 dollars. In this example, the payment is for maintenance work the refrigerator maintenance company performed on the user's refrigerator back home in Minnesota. The payment request is submitted and transmitted by the smartphone 30.

The EPSD 16 receives the payment request, confirms the payor and payee accounts are true accounts and/or performs one or more fraud checks and determines the requested payment is not fraudulent, confirms there is sufficient liquidity in the payor account for the request payment, and transmits a request to the smartphone 30 for the user to confirm the payment details.

Meanwhile, and in parallel, the prompt generation module 35 generates a prompt based on the payment amount, context data, and user data 28, and feeds the prompt to the GAIM 37. In this example, the context data includes that the smartphone 30 is in Paris and that the user has a degree in history.

The GAIM 37 generates an educational text string based on the prompt, the context, and the user data 28, of “the Eiffel Tower was completed in the year 1889”, with the context data having provided the GAIM 37 with the user's location in Paris and the user data 28 having provided the GAIM 37 with data indicating that the user has a degree in history. These pieces of data were used by the GAIM 37, together with the amount of the transaction, to generate the educational text string.

The educational text string and request for feedback are then transmitted to the smartphone 30.

In some examples, the user provides feedback in response to the feedback request which can be used to further train the GAIM 37 and update the user data 28.

In some examples, the user may not confirm the requested payment until providing feedback regarding the educational text string.

Via the smartphone 30, the user can then confirm, cancel, or revise the payment, which decision is then transmitted to EPSD 16 for further processing and, if the payment is confirmed, initiation of the payment.

The GAIM 37 includes a number corresponding to the payment amount of the payment request. In some examples, the number is in a currency unit. In other examples, the number is not in a currency unit. In some examples, the number includes some but not all of the digits of the amount of the payment request, e.g., leaving off digits corresponding to a fraction of a dollar. In some examples, the number includes all of the digits of the payment request. For example, a number in an educational text string corresponding to the dollar amount 1,889.22 dollars can be 1889 in some examples, or 188,922 in other examples.

Some additional examples of how educational text strings can incorporate numbers corresponding to payment amounts from transaction requests will now be provided.

For an entered amount of 10.12 dollars, the generated educational text string can be “The deepest part of the ocean, the Mariana Trench is about 10.12 kilometers deep.”

For an entered amount of 1,785 dollars, the generated educational text string can be “In 1785, the dollar was established as the official currency of the United States.”

For an entered amount of 10,000 dollars, the generated educational text string can be “Mount Everest grows about 10,000 millimeters every century.”

For an entered amount of 20,000 dollars, the generated educational text string can be “The average cost of a wedding in the United States was around $20,000 in 2021.”

For an entered amount of 1,000,000 dollars, the generated educational text string can be “A million seconds is about 11 and a half days.”

For an entered amount of 10,000,000 dollars, the generated educational text string can be “Honeybees must visit about 10 million flowers”.

In some examples, e.g., depending on the order of magnitude of the payment amount, the number corresponding to the payment amount that is included in the educational text string can include a word rather than only numbers. For example, if the payment amount is at least 1,000 dollars, then the educational text string will include the corresponding number with a word, such as “thousand” or “million”.

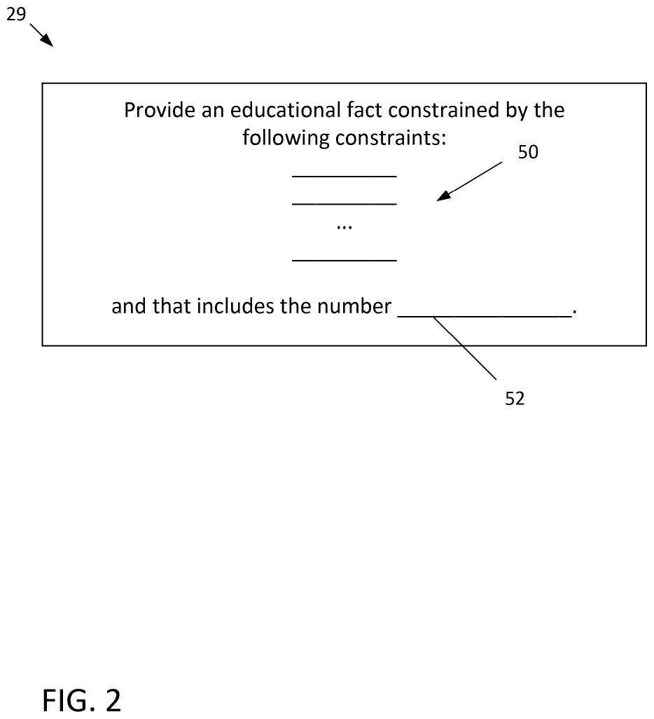

FIG. 2 shows an example generative artificial intelligence model (GAIM) prompt template 29 of FIG. 1.

The prompt template 29 can be a data structure, e.g., a data table, stored on the database(s) 27.

The prompt template 29 includes blanks 50 (e.g., editable open fields) for constraints and a blank 52 (e.g., an editable open field) for the number corresponding to the amount of the requested payment.

The blanks 50 can be filled in with any number of constraints that can be user and/or transaction specific. For example, the constraints can include that the educational fact must be historical, and/or must relate to architecture, and/or must relate to rugby, and/or must relate to a particular country and/or city, and/or must relate to a particular season of the year or month of the year, or day of the week, or time of day, and/or must not relate to classical music, and the like.

The server 14 fills in the blanks 50 based on contextual data provided as metadata data from the client device 30, and/or based on user data 28, and/or based on prior feedback to prior educational text strings from a user associated with the payor account 38.

The server 14 fills in the blank 52 with a number corresponding to the amount of the requested payment. The number that is filled into the blank 52 can include all of the digits of the amount or fewer than all of the digits of the payment amount.

In some examples, the number that is filled into the blank 52 is unitless. In some examples, the number that is filled into the blank 52 has a unit (e.g., a currency unit, a time unit, a physical quantity unit, and the like) selected by the server 14 based on contextual data provided as metadata data from the client device 30, and/or based on user data 28, and/or based on prior feedback to prior educational text strings from a user associated with the payor account 38.

FIG. 3 shows an example user interface 60 that can be generated by the system of FIG. 1. In particular, the interface 60 can be generated by a display output device of the client device 30 based on data signals provided to the client device 30 from both the server 14 and the EPSD 16. In some examples, these signals are provided to the client device 30 by the server 14 and the EPSD 16 simultaneously, with the signals provided by the EPSD 16 being payment workflow signals and the signals provided by the server 14 being augmentation workflow signals, and with the two workflows operating in parallel.

The interface 60 includes payment workflow area 61 that provides the payment details of the requested payment, including the amount (356.27 dollars) of the requested payment, the payor account 38 (Checking Account X), and the payee (Whale Watch Company Y). The data displayed in the area 61 is provided by the EPSD 16.

The interface 60 includes an augmentation workflow area 62. The augmentation workflow area 62 serves as a checkpoint in the payment workflow. The data displayed in the area 62 is provided by the server 14. The augmentation workflow area 62 includes an educational text string 63 generated by the GAIM 37. The text string 63 is generated based on user data 28 (e.g., the user majored in biology), context metadata (e.g., the type of payee), and the amount of the requested payment (in this case, the number 356 is used in the text string 63 based on the amount of 356.27 dollars).

The augmentation workflow area 62 also includes a feedback area via which feedback to the educational text string 63 can be provided from the client device 30 to the server 14 and the GAIM 37. In this example, buttons 64 and 65 (e.g., thumbs up and thumbs down buttons) are provided for indicating approval or disapproval, respectively, of the educational text string 63. Other forms of feedback input mechanisms are possible.

The interface 60 also includes selectable inputs (e.g., buttons) 66, 67, 68 for, respectively, confirming the payment, revising the payment, or canceling the payment. Consideration by the user of the checkpoint can cause the user to realize, for example, that one or more of the payment details are incorrect, and therefore select the button 67 to revise the payment details or the button 68 to cancel the payment. Selection of one of the buttons 66, 67, 68 generates signals that are transmitted to the EPSD 16.

If the button 66 is selected, the EPSD 16 initiates the payment.

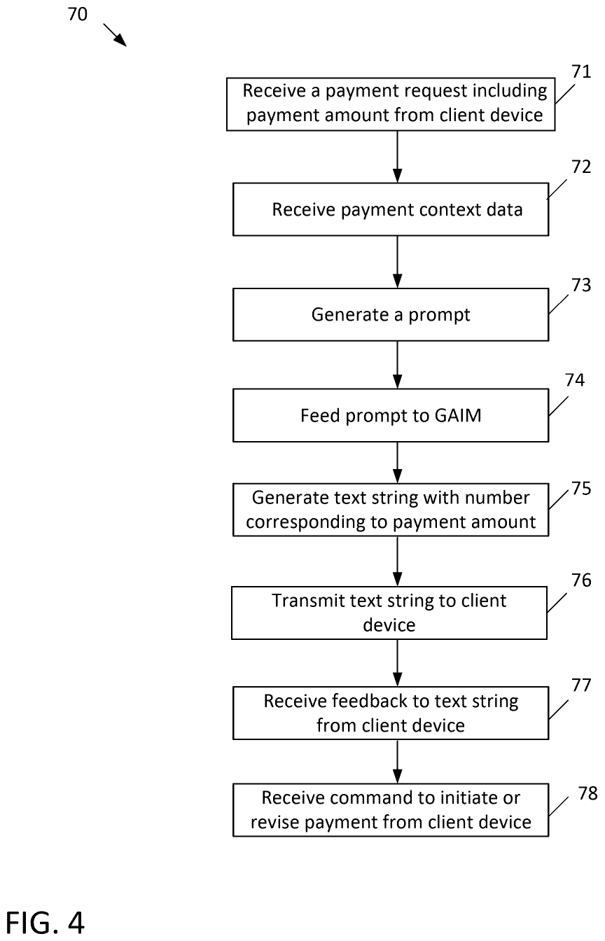

FIG. 4 shows an example method 70 that can be performed by the system of FIG. 1. Methods of the present disclosure can include more or fewer steps than the enumerated steps of method 70. Methods of the present disclosure can include steps of the method 70 performed in a different order than depicted. In some examples, the steps of the method 70 are performed by the server 14.

At a step 71 of the method 70, a payment request is received from a client device 30. The payment request includes a payment amount.

At a step 72 of the method 70, context data is received. The context data can include metadata provided by the client device 30. The context data can include user data 28.

At a step 73 of the method 70, a prompt is generated based on the payment amount and the context data.

At a step 74 of the method 70, the prompt is fed to the GAIM 37.

At a step 75 of the method 70, the GAIM generates an educational text string based on the prompt and including a number corresponding to the amount of the payment.

At a step 76 of the method 70, the educational text string is transmitted to the client device 30.

At a step 77 of the method 70, feedback to the educational text string is received from the client device 30. In some examples, the feedback is used to further train the GAIM 37 and/or is added to the user data 28.

At a step 78 of the method 70, a command to initiate, revise (or cancel) the payment is received from the client device.

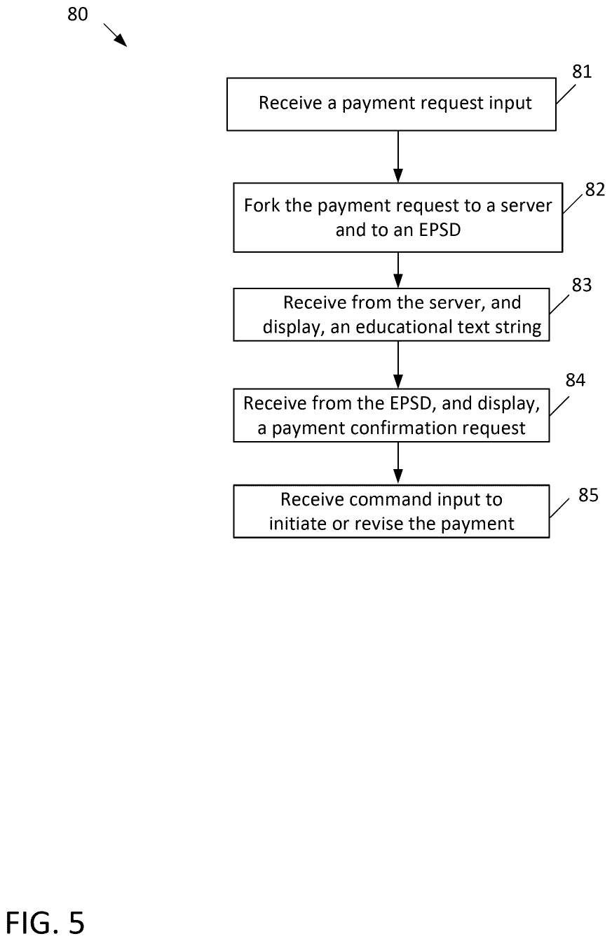

FIG. 5 shows another example method 80 that can be performed by the system of FIG. 1. Methods of the present disclosure can include more or fewer than the enumerated steps of method 80. Methods of the present disclosure can include steps of the method 80 performed in a different order than depicted. In some examples, the steps of the method 80 are performed by the client device 30.

At a step 81 of the method 80, a payment request input is received.

At a step 82 of the method 80, the payment request is forked to the server 14 and to the EPSD 16. In some examples, the request is transmitted simultaneously from the client device 30 to each of the server 14 and the EPSD 16.

At a step 83 of the method 80, an educational text string is received from the server 14 and displayed.

At a step 84 of the method 80, a request to confirm, revise and/or cancel the payment is received from the EPSD 16. In some examples, the steps 83 and 84 occur simultaneously and a single user interface is generated based on the signals received from both the server 14 and the EPSD 16.

At a step 85 of the method 80, a command input to initiate, revise and/or cancel the payment is received via the interface that has been generated.

### Example Computing Environment

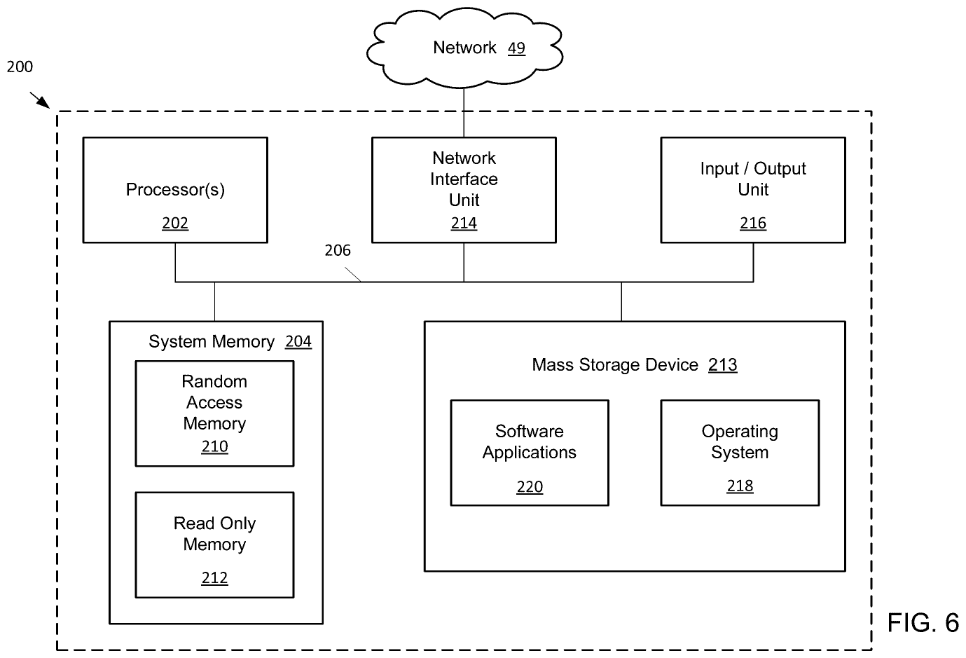

Additional components of the system 10 of FIG. 1 are illustrated in FIG. 6.

The electronic computing device 200 can correspond to any of the computing devices 14, 16, or 30 of the system 10 of FIG. 1. Components of the computing device 200 can correspond to other components of the system 10 of FIG. 1, such as the database(s) 27.

When the computing device 200 corresponds to the server 14, the computing device 200 can be an internally controlled and managed device (or multiple devices) of an enterprise, e.g., a financial institution that offers various banking services to its customers. Alternatively, the computing device 200 can represent one or more devices operating in a shared computing system external to the enterprise, such as a cloud.

Via the network 49, any components of the computing device 200 that are physically remote from one another can interact with one another, as well as with other computing resources, such as those shown in FIG. 1. The network 49 can be any suitable wired, wireless, cellular or other data network (or combination of networks) that enables data transmission between computing devices networked together.

The electronic computing device 200 includes one or more processors 202. The one or more processors 202 are configured to carry out the functionality of the system 10 described above by executing computer-readable instructions stored on non-transitory computer-readable storage. The electronic computing device 200 also includes a system memory 204 and a system bus 206 that couples the system memory 204 to the processor(s) 202.

The system memory 204 includes a random access memory (“RAM”) 210 and a read-only memory (“ROM”) 212. A basic input/output system that contains the basic routines that help to transfer information between elements within the electronic computing device 200, such as during startup, is stored in the ROM 212.

The electronic computing device 200 further includes a mass storage device 213. The mass storage device 213 is able to store software instructions and data such as the user data 28, the prompt template 29, the payor account 38, the prompt generation module 35, the feedback request module 34, the GAIM 37, and the training module 36, as well any other instructions needed to carry out any further functions of the devices of the system 10 of FIG. 1.

The mass storage device 213 is connected to the processor(s) 202 through a mass storage controller (not shown) connected to the system bus 206. The mass storage device 213 and its associated computer-readable data storage media provide non-volatile, non-transitory storage for the computing device 200. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 200.

According to various embodiments of the invention, the computing device 200 may operate in a networked environment using logical connections to remote network devices (such as other computing devices of the system of FIG. 10) through the network 49, such as a wireless network, the internet, or another type of network. The electronic computing device 200 may connect to the network 49 through a network interface unit 214 connected to the system bus 206. It should be appreciated that the network interface unit 214 may also be utilized to connect to other types of networks and remote computing systems. The electronic computing device 200 also includes an input/output unit 216 for receiving and processing input from a number of other devices, including a touch user interface display screen, an audio input device, or another type of input device.

As mentioned briefly above, the mass storage device 213 and/or the RAM 210 of the electronic computing device 200 can store software instructions and data. The software instructions include an operating system 218 suitable for controlling the operation of the electronic computing device 200. The mass storage device 213 and/or the RAM 210 also store software instructions and applications 220, that when executed by the processor(s) 202, cause the electronic computing device 200 to provide functionality of the system 10 described above (FIG. 1).

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer-implemented payment method, comprising:
receiving, by a server, a payment request from a client electronic computing device, the payment request including an amount of a payment;
generating, by the server, a prompt based on the amount;
feeding, by the server, the prompt to a generative artificial intelligence model (GAIM);
generating, by the GAIM and in response to the prompt, a text string that includes a number corresponding to the amount;
generating, by the server, first signals that cause the client electronic computing device to display the text string;
receiving, by the server, second signals from the client electronic computing device in response to a request to confirm the payment, the second signals indicating whether the payment has been confirmed.

2. The method of claim 1, wherein the prompt is generated by the server based on a contextual factor.

3. The method of claim 2, wherein the contextual factor is based on feedback received by the server to another text string generated in response to a previous payment request.

4. The method of claim 2, wherein the contextual factor is based on a type of a good or a type of a service that the payment is for.

5. The method of claim 2, wherein the contextual factor is based on a physical location of the client electronic computing device.

6. The method of claim 1, further comprising:
generating, by the server, third signals that cause the client electronic computing device to display a feedback request related to the text string and;
receiving, by the server, feedback about the text string from the client electronic computing device, the feedback being in response to the feedback request.

7. The method of claim 1, further comprising:
prior to receiving the payment request, training the GAIM to generate educational text strings, including the text string.

8. The method of claim 7, wherein the training includes feeding the GAIM user data associated with financial accounts from which payment requests, including the payment request, are made.

9. The method of claim 8, wherein the user data includes data about education of users, data about employers of the users, data about family members of the users, data about geographic areas surrounding homes of the users, data about spending habits of the users, and data about feedback by the users to previous text strings generated in response to previous payment requests.

10. The method of claim 1, wherein the number included in the text string is not in a unit of currency.

11. The method of claim 1,
wherein the second signals indicate that that the payment is confirmed, the method further comprising:
electronically initiating the payment by an electronic payment service device.

12. A computer-implemented payment method, comprising:
receiving, by a client electronic computing device, input corresponding to a payment request, the payment request including an amount of a payment;
transmitting the payment request from the client electronic computing device, including forking the payment request from the client electronic computing device to each of a server and an electronic payment service device, the server being associated with a trained generative artificial intelligence model (GAIM);
receiving, by the client electronic computing device and from the server, an educational text string generated by the trained GAIM that includes a number corresponding to the amount;
receiving, by the client electronic computing device and from the electronic payment service device, a confirmation request to confirm the payment; and
receiving, by the client electronic computing device, another input responding to the confirmation request, the another input causing the payment request to be initiated or causing the client electronic computing device to request at least one revision to the payment request.

13. The method of claim 12, further comprising:
receiving, by the client electronic computing device, feedback to the educational text string; and
transmitting the feedback to the server.

14. The method of claim 13, wherein the feedback is provided, by the server, to the trained GAIM causing the trained GAIM to be further trained.

15. The method of claim 13, further comprising transmitting the another input to the electronic payment service device.

16. The method of claim 12, further comprising simultaneously displaying the confirmation request and the educational text string on a display of the client electronic computing device.

17. The method of claim 12, further comprising transmitting, from the client electronic computing device, contextual data associated with the payment request,
wherein the educational text string is generated based on the contextual data.

18. The method of claim 17, wherein the contextual data includes one or more of: data about an education of a user, data about an employer of the user, data about a family member of the user, data about a geographic area surrounding a home of the user, data about spending habits of the user, and data about feedback from the user to a previous educational text string generated in response to a previous payment request.

19. A system for managing payments, comprising:
a server;
an electronic payment service device;
processors included in the server and the electronic payment service device; and
non-transitory computer readable storage storing instructions which, when executed by the processors, cause the processors to:
process in parallel by the server and the electronic payment service device a payment request received from a client electronic computing device, causing:
the server to generate a prompt;
the server to feed the prompt to a trained generative artificial intelligence model (GAIM);
the trained GAIM to generate an educational text string including a number corresponding to an amount of a payment included in the payment request;
the server to transmit the educational text string to the client electronic computing device;
the electronic payment service device to generate a confirmation request to confirm the payment; and
the electronic payment service device to transmit the confirmation request to the client electronic computing device.

20. The system of claim 19, wherein the educational text string and the confirmation request are transmitted to the client electronic computing device simultaneously.
